(19) United States
(12) Patent Application Publication
(10) Pub. No.: US 2020/0207535 A1
(43) Pub. Date: Jul. 2, 2020

(54) BEVERAGE INGREDIENT CARTRIDGE

(71) Applicant: PepsiCo, Inc., Purchase, NY (US)

(72) Inventors: Advait BHAT, White Plains, NY (US); Girish Nilkanth DESHPANDE, Carmel, NY (US); Maximiliano RODRIGUEZ, Bridgewater, NJ (US); Benjamin Joseph TANTANELLA, New York, NY (US); Bruno TELESCA, Sandy Hook, CT (US); Alexander David WARNING, Peekskill, NY (US); Lei ZHAO, Nanuet, NY (US); Nathan Daniel GRUBBS, West Chester, OH (US); Ryan Alan KLENKE, St. Henry, OH (US)

(21) Appl. No.: 16/235,346

(22) Filed: Dec. 28, 2018

(51) Int. Cl. B65D 81/32; B65D 47/36; A47J 31/40; B65D 51/28; B65D 43/02

(52) U.S. Cl. CPC B65D 81/32; B65D 47/36; B65D 2101/00; B65D 51/28; B65D 43/0235; A47J 31/407

(57) ABSTRACT

A beverage ingredient cartridge for releasing beverage ingredients into a bottle to create a mixed beverage includes a body defining a liquid-ingredient chamber, a cap defining a solid-ingredient chamber, and an opening mechanism disposed on the cap. Upon a force applied to the beverage ingredient cartridge, a piercer of the bottle drives through the dispensing end of the cartridge, causing teeth of the opening mechanism to tear through films sealing the liquid-ingredient chamber and solid-ingredient chamber. This mixes contents of the liquid-ingredient chamber with contents of the solid-ingredient chamber and releases the mixed contents from the beverage ingredient cartridge into a bottle below that is filled with a liquid, creating a mixed beverage.

### FIELD

The described embodiments generally relate to beverage ingredient cartridges. In particular, embodiments relate to multi-chambered beverage ingredient cartridges for dispensing beverage ingredients into beverage containers.

### BRIEF SUMMARY

Embodiments of the present invention provide beverage ingredient cartridges that can contain and be used to dispense multiple ingredients into beverage containers. They allow a user to create their own beverage at the point of use, and in doing so reduce waste and cost associated with production and delivery of pre-mixed bottled beverages. The cartridges may include a body defining a first-ingredient chamber and a cap defining a second-ingredient chamber. The cap may include an opening mechanism having teeth that extend toward films that seal the first and second ingredient chambers. When a piercer of the beverage container is pressed against the opening mechanism, the teeth of the opening mechanism may first puncture, then tear, the seals of the first and second ingredient chambers. This releases contents of both the first-ingredient chamber and the second-ingredient chamber through a dispensing end of the cartridge. The contents mix with a liquid in the beverage container to create a mixed beverage.

For example, embodiments include a beverage ingredient cartridge where the cartridge includes a body defining a first-ingredient chamber. The first-ingredient chamber may have an opening at an upper end of the body and may have a film extending over the opening and sealing the first-ingredient chamber. The cartridge also may include a cap defining a second-ingredient chamber. The cap may include an opening mechanism that defines an upper side of the second-ingredient chamber, and may have a second-ingredient-chamber film that defines a lower side of the second-ingredient chamber. The opening mechanism may include two flaps that are hingedly connected to an upper rim of the cap, and each of the flaps may have teeth extending into the second-ingredient chamber. The flaps may be rotatably movable from a closed position to an open position and, in the closed position, the flaps may together form a flat circular shape and seal an upper side of the second-ingredient chamber. When the flaps transition from the closed position to the open position, the teeth may tear through both the second-ingredient-chamber film and the first-ingredient-chamber film, which opens both the second-ingredient chamber and the first-ingredient chamber to an exterior of the beverage ingredient cartridge.

Embodiments also include a beverage ingredient cartridge where the cartridge includes a film seal and an opening mechanism. The opening mechanism may include only two flaps that are positioned above the film seal. The outer edges of the two flaps may together form a circle when in a closed position, and each flap may have an axis of rotation formed at an edge of the circle. Each of the flaps may have teeth extending toward the film seal, and a tooth of each flap may be positioned a distance from its flap's axis of rotation that is greater than the radius of the circle formed by the edges of the flaps.

Embodiments also include a beverage ingredient cartridge where the cartridge includes a body defining a first-ingredient chamber. The first-ingredient chamber may have an opening at an upper end of the body and may have a film extending over the opening and sealing the first-ingredient chamber. The cartridge may also include a cap defining a second-ingredient chamber. The cap may include an opening mechanism that defines an upper side of the second-ingredient chamber and a second-ingredient-chamber film that defines a lower side of the second-ingredient chamber. The opening mechanism may be configured to tear through both the first-ingredient-chamber film and the second-ingredient-chamber film by piercing and applying forces in opposing directions that are tangent to the direction of extension of the first-ingredient-chamber film and the second-ingredient-chamber film. Each of the body, first-ingredient-chamber film, cap, and second-ingredient-chamber film may be formed entirely of polyethylene terephthalate.

### BRIEF DESCRIPTION OF THE FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a partial sectional view of a beverage ingredient cartridge and a bottle.

FIG. 2 is a partial sectional view of the beverage ingredient cartridge of FIG. 1 being dispensed into the bottle of FIG. 1.

FIG. 3 is a partial sectional exploded view of a beverage ingredient cartridge.

FIG. 4 is a partial sectional view of the beverage ingredient cartridge of FIG. 3.

FIG. 5A is a bottom perspective view of a cap of a beverage ingredient cartridge.

FIG. 5B is a bottom perspective view of a cap of a beverage ingredient cartridge.

FIG. 5C is a bottom perspective view of a cap of a beverage ingredient cartridge.

FIG. 6 is a top view of a cap of a beverage ingredient cartridge.

FIG. 7 is a partial transparent side view of a beverage ingredient cartridge inverted over a cartridge piercer in a first state during a dispensing operation.

FIG. 8 is a partial transparent side view of the beverage ingredient cartridge and cartridge piercer of FIG. 7 in a second state during a dispensing operation.

FIG. 9 is a partial transparent side view of the beverage ingredient cartridge and cartridge piercer of FIG. 7 in a third state during a dispensing operation.

FIG. 10 is a top view of the cap of the beverage ingredient cartridge and the cartridge piercer of FIG. 9.

FIG. 11 is a bottom perspective view of a cap of a beverage ingredient cartridge.

FIG. 12 is an enlarged partial sectional view of a portion of the beverage ingredient cartridge of FIG. 4.

### DETAILED DESCRIPTION

The present invention(s) will now be described in detail with reference to embodiments thereof as illustrated in the accompanying drawings. References to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Pre-made beverages have long been distributed to consumers in various forms of packaging, often in plastic bottles. A significant proportion of such bottled pre-made beverages' weight and volume is often attributable to water, as a constituent part of the beverage. Significant proportions of production, shipping, storage, and other manufacturing and distribution costs are often derived from this volume and weight due to water content of a pre-made beverage.

Further, the disposal of the bottle containing the pre-made beverage after the beverage is consumed often involves recycling or other waste management processes applied to the bottle. The cost and complexity of such processes are often proportional to the volume of material forming the bottle.

Beverage ingredient cartridges as described herein may contain ingredients, such as, for example, concentrated flavorings, nutrients, or other beverage additives, and may be used by consumers with a bottle or other reusable beverage container containing a liquid, such as water, juice, milk, or seltzer, to create a mixed beverage.

Some embodiments described herein provide cartridges that include multiple separate ingredient chambers for storing ingredients (for example dry and liquid ingredients) separately that may be dispensed simultaneously into a reusable beverage container in an easy and efficient manner. Such cartridges may be smaller than conventional beverage bottles, requiring less material and reducing potential manufacturing, distribution, and disposal complexity and cost. Cartridges according to some embodiments may be made completely from recyclable material, further reducing the waste associated with the production of such beverage mixtures. Allowing a consumer to participate in the creation of a new beverage may also enhance consumer experience with an added perception of freshness.

To use beverage ingredient cartridges in accordance with some embodiments of the invention, a dispensing end of the beverage ingredient cartridge may be placed in the opening of a bottle or other reusable beverage container configured to accept the cartridge and facilitate dispensing of the cartridge's contents. The user then presses down on the cartridge, which presses the dispensing end of the cartridge against a piercer of the reusable beverage container. Several flaps that have teeth and that are disposed on the dispensing end of the cartridge rotate inside the cartridge as the piercer moves through the dispensing end of the cartridge. This causes the teeth to puncture and tear through membranes sealing internal chambers of the cartridge, thereby releasing the beverage ingredients contained within the cartridge into the reusable beverage container, creating a new, freshly mixed beverage for the consumer to enjoy.

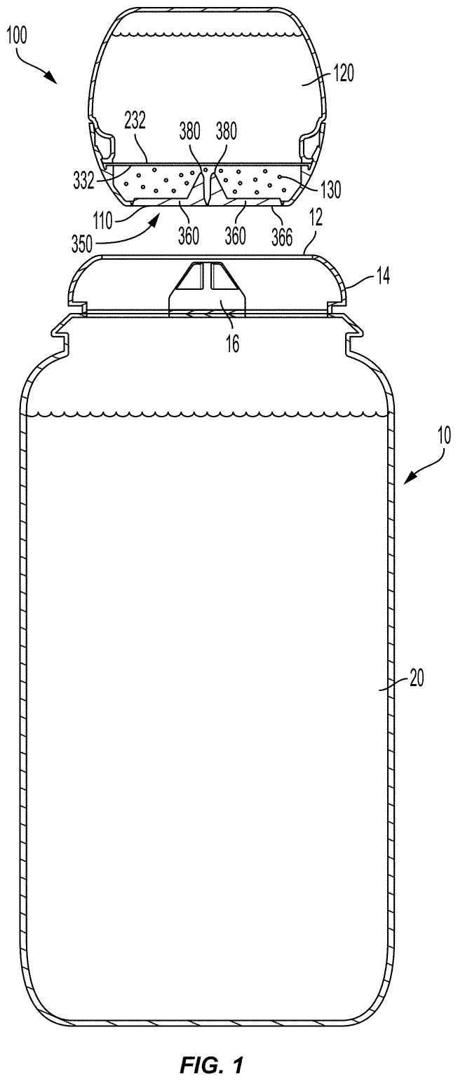

Embodiments of the invention will now be described in more detail with reference to the figures. FIG. 1 shows a beverage ingredient cartridge 100 positioned above a bottle 10, the cartridge 100 having a dispensing end 110 facing an opening 12 of the bottle 10. The beverage ingredient cartridge 100 may contain separately stored ingredients, such as, for example, a liquid beverage ingredient 120 (a first beverage ingredient) and a solid beverage ingredient 130 (a second beverage ingredient), and bottle 10 may contain a liquid 20 (e.g., water, juice, milk, or seltzer). The bottle may include an engagement portion 14 configured to receive and open the beverage ingredient cartridge 100. Bottle 10 may be any suitable type of beverage container such as, for example, a bottle, cup, mug, tumbler, glass, pitcher, or the like. Such beverage container may include structure to facilitate opening of cartridge 100 (like engagement portion 14 of bottle 10), or may be used with a separate removable structure for opening cartridge 100 (e.g., piercing apparatus 600 of U.S. patent application Ser. No. 15/182,356, filed Jun. 14, 2016, which is incorporated herein in its entirety by reference thereto).

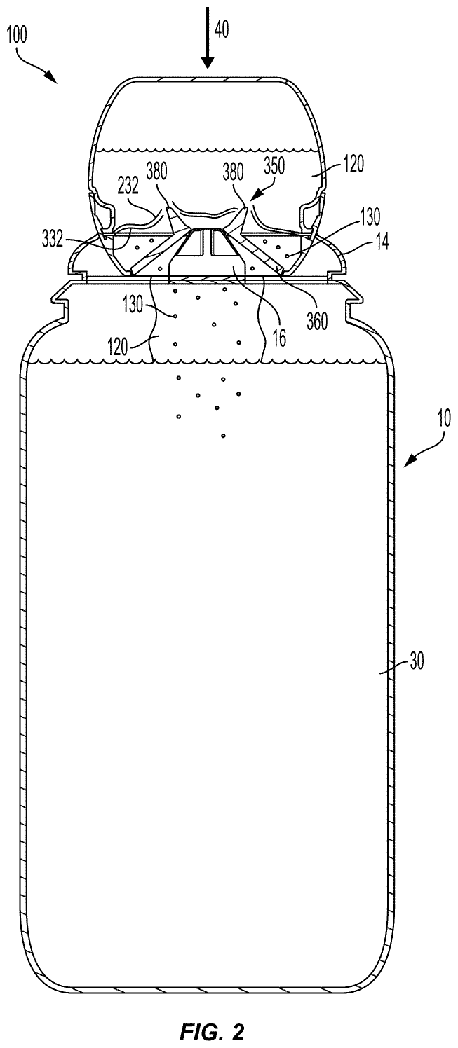

As shown in FIG. 2, an axial force 40 may be applied to beverage ingredient cartridge 100, pushing cartridge 100 against a cartridge piercer 16 of engagement portion 14, thereby dispensing beverage ingredients 120, 130 into bottle 10 to mix with liquid 20, thereby creating a new beverage mixture 30. Cartridge piercer 16 may be any structure capable of opposing force 40 to thereby apply force to dispensing end 110 of beverage ingredient cartridge 100.

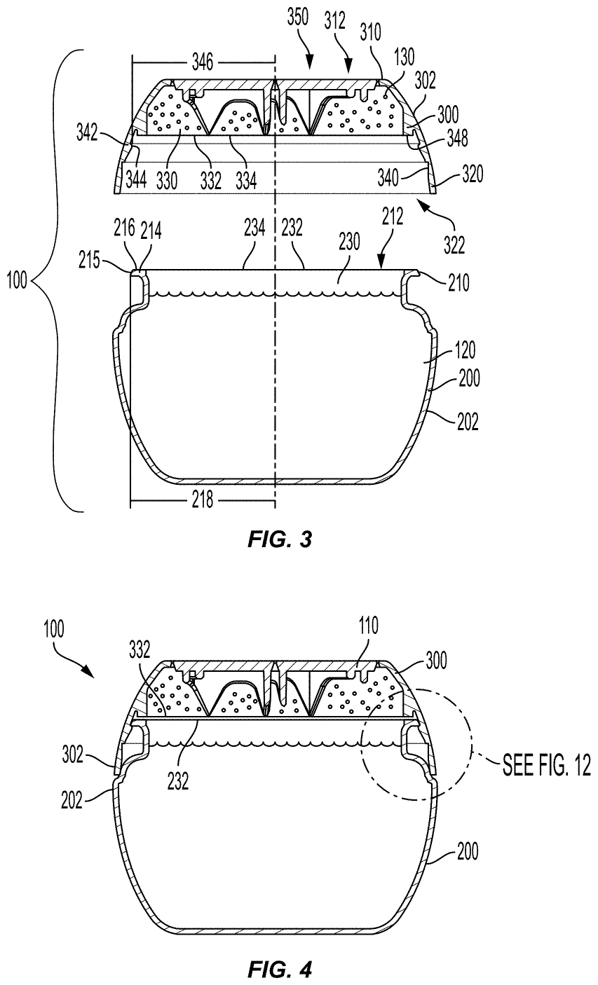

As shown in FIGS. 3-4, beverage ingredient cartridge 100 may include a body 200 and a cap 300. In some embodiments, all of the components of beverage ingredient cartridge 100 (with the exception of any beverage ingredients contained therein) may be made from recyclable material. The material may be suitable for use in a variety of beverage production processes, such as hot-fill processing or aseptic processing. In some embodiments, all of the components of beverage ingredient cartridge 100 (with the exception of any beverage ingredients contained therein) may be made from plastic such as, for example, polyethylene terephthalate (PET). Making the entirety of beverage cartridge 100 from the same material, particularly when that material is readily recyclable (e.g., PET), allows a used, empty cartridge to be recycled in a single-stream recycling process without the need to undertake expensive and complicated disassembly and sorting procedures. It also can help reduce introduction of contaminants into a (for example PET) recycling stream, since there will be no other material type in beverage cartridge 100 to contaminate the stream.

Body 200 may define a liquid-ingredient chamber 230 for containing a liquid beverage ingredient 120 (such as, for example, a flavoring, concentrated flavoring, syrup, or other fluid beverage additive) that may be dispensed from dispensing end 110 into bottle 10 to form a beverage mixture 30 (see, for example, FIG. 2). Body 200 is shown to have a generally semispherical shape, however it may take other shapes as well, including, for example, cylindrical, spherical, frustoconical, or cubical, and it may or may not be symmetrical about any axis.

A liquid-ingredient-chamber film 232 may be disposed across an opening 212 on a first end 210 of body 200, thereby sealing liquid-ingredient chamber 230. In some embodiments, opening 212 may be circular and have a diameter of approximately 25-50 millimeters. An annular rim 214 may be disposed around opening 212 and may include a annular surface 216 upon which liquid-ingredient-chamber film 232 may be adhered to body 200. Annular rim 214 may also be used to secure body 200 to cap 300, as described in further detail below. In some embodiments, liquid-ingredient-chamber film 232 may be made of plastic (e.g., the same type of plastic as the other components of beverage ingredient cartridge 100. In some embodiments, liquid-ingredient-chamber film 232 may be made of polyethylene terephthalate (PET). In some embodiments, liquid-ingredient-chamber film 232 includes oxygen barrier properties that resist the ingress of oxygen into the liquid-ingredient chamber 230.

As shown, for example, in FIGS. 3 and 4, cap 300 may define a solid-ingredient chamber 330 for containing a solid beverage ingredient 130 (such as, for example, a granulated sweetener, sugar, or other solid beverage additive) that may be dispensed from dispensing end 110 into bottle 10 to form a beverage mixture 30 (see, for example, FIG. 2). As with body 200, cap 300 is not limited to the shape and appearance shown, but may take on a variety of shapes and appearances.

For convenience of description, beverage ingredient chamber 230 of body 200 is referenced herein as “liquid-ingredient chamber 230” and beverage ingredient chamber 330 of cap 300 is referenced herein as “solid-ingredient chamber 330,” however both beverage ingredient chambers 230 and 330 may contain any type of beverage ingredient, (e.g., solid beverage ingredients, liquid beverage ingredients, or both solid beverage ingredients and liquid beverage ingredients).

Cap 300 may have a first end 310 having a first opening 312 defined by a first perimeter 314. In some embodiments, first perimeter 314 may be circular and have a diameter of approximately 20-45 millimeters. Cap 300 may have a second end 320 disposed opposite first end 310 and having a second opening 322 defined by a second perimeter 324. In some embodiments, second perimeter 324 may be circular and have a diameter of approximately 40-60 millimeters. As described in further detail below, during a dispensing operation, beverage ingredient cartridge 100 may be oriented such that cap 300 is disposed beneath body 200. Thus, liquid beverage ingredients 120 may pass from liquid-ingredient chamber 230, into cap 300, and finally dispensing through first opening 312 on dispensing end 110 of beverage ingredient cartridge 100. In some embodiments, the diameter of second perimeter 324 may be less than the diameter of first perimeter 314. In this manner, cap 300 may funnel liquid beverage ingredients into bottle 10.

In some embodiments, a sealing rim 348 may be disposed on an interior surface 340 of cap 300. A solid-ingredient-chamber film 332 may be disposed across sealing rim 348, thus sealing a lower end of the solid-ingredient chamber 330. In some embodiments, sealing rim 348 is annular, and the inner diameter of sealing rim 348 is approximately the same as the diameter of opening 212. In some embodiments, solid-ingredient-chamber film 332 may be made of plastic (e.g., the same type of plastic as the other components of beverage ingredient cartridge 100. In some embodiments, solid-ingredient-chamber film 332 may be made of polyethylene terephthalate (PET). In some embodiments, solid-ingredient-chamber film 332 includes oxygen barrier properties that resist the ingress of oxygen into the solid-ingredient chamber 330.

Cap 300 may include an opening mechanism 350. Opening mechanism 350 may include flaps 360, ridges 370, and teeth 380. Opening mechanism 350 may be disposed on first end of 310 of cap 300, and may seal first opening 312, thus sealing an upper end of solid-ingredient chamber 330. Opening mechanism 350 may be configured to release the beverage ingredients 120, 130 from both the solid and liquid ingredient chambers 230, 330, as will be apparent from the below description.

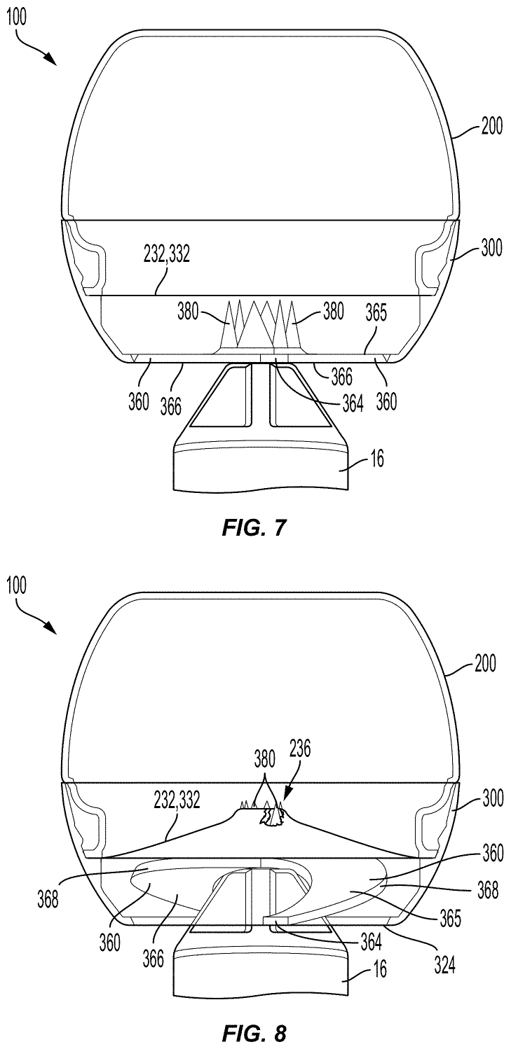

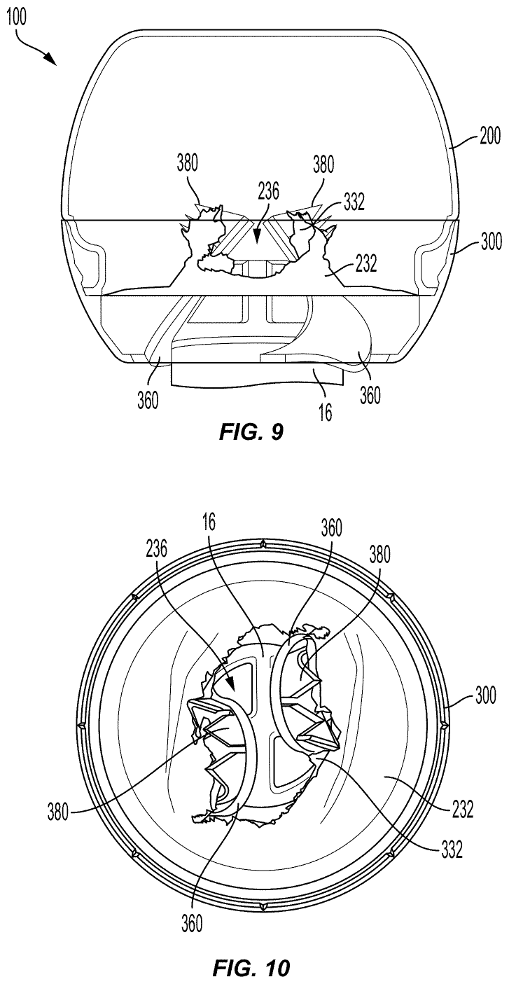

Flaps 360 may be connected to cap 300 and configured to seal first opening 312 when in a closed position. Each flap 360 may have a first end 361 and a second end 362 disposed opposite the first end 361. A hinge 364 may be configured to rotatably connect second end 362 of flap 360 to first perimeter 314. For example, when a force is applied to an exterior surface 366 of flap 360, the flap 360 may rotate about hinge 364 from a closed position (see, for example, FIG. 7) to an open position (see, for example, FIG. 9).

Opening mechanism may include various numbers of flaps 360, and flaps 360 may have a variety of different shapes. Flaps 360 may be configured such that, when in a closed position, the shape of the flaps 360, together, matches the shape of first opening 312, thereby sealing first opening 312. For example, in some embodiments, first opening 312 may have a circular shape, and two semicircular flaps 360 may be configured to fill and seal first opening 312. In some embodiments, first opening 312 may have a circular shape, and four flaps 360—each having the shape of a quadrant of a circle—may be configured to fill and seal first opening 312. In some embodiments, each flap 360 of opening mechanism 350 may have the same shape. In some embodiments, each flap 360 of opening mechanism 350 may have a different shape. In some embodiments, each flap 360 of opening mechanism 350 may have a degree of symmetry. In some embodiments, flaps 360 of opening mechanism 350 may have no symmetry with one another. In some embodiments, flaps 360 may be substantially flat on their outer surface.

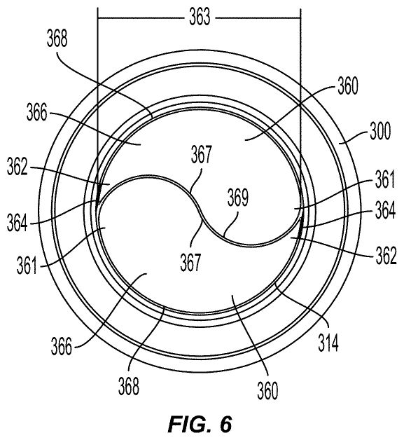

As shown in FIG. 6, each flap 360 may include an inner edge 367 and an outer edge 368. Outer edge 368 may be the edge of the portion of the flap 360 that is disposed adjacent to first perimeter 314 when in a closed position. Inner edge 367 of flap 360 may be the edge of the portion of the flap 360 that is disposed adjacent to the inner edge 367 of another flap 360 when in a closed position. A flap interface 369 is formed where the inner edges 367 of two flaps 360 meet when in a closed position.

Flap interface 369 may be straight, curved, or may include both straight and curved portions. As shown in FIG. 6, for example, opening mechanism 350 may include two flaps 360 that meet at an S-shaped flap interface 369. Flap interface 369 is not limited to the shapes shown in the figures, but may take on a variety of shapes.

In some embodiments, outer edge 368 is continuously sealed to first perimeter 314 along the length of outer edge 368. Likewise, flaps 360 may be continuously sealed together along flap interface 369. In this manner, flaps 360 may completely seal first opening 312 when in a closed position. The seals along outer edge 368 and flap interface 369 may be, for example, weakened portions of material configured to break during a dispensing operation. For example, when a force is applied to exterior surface 366, flaps 360 may separate from first perimeter 314 along outer edges 368, and separate from one another along flap interface 369, such that each flap 360 may rotate independently about its respective hinge 364.

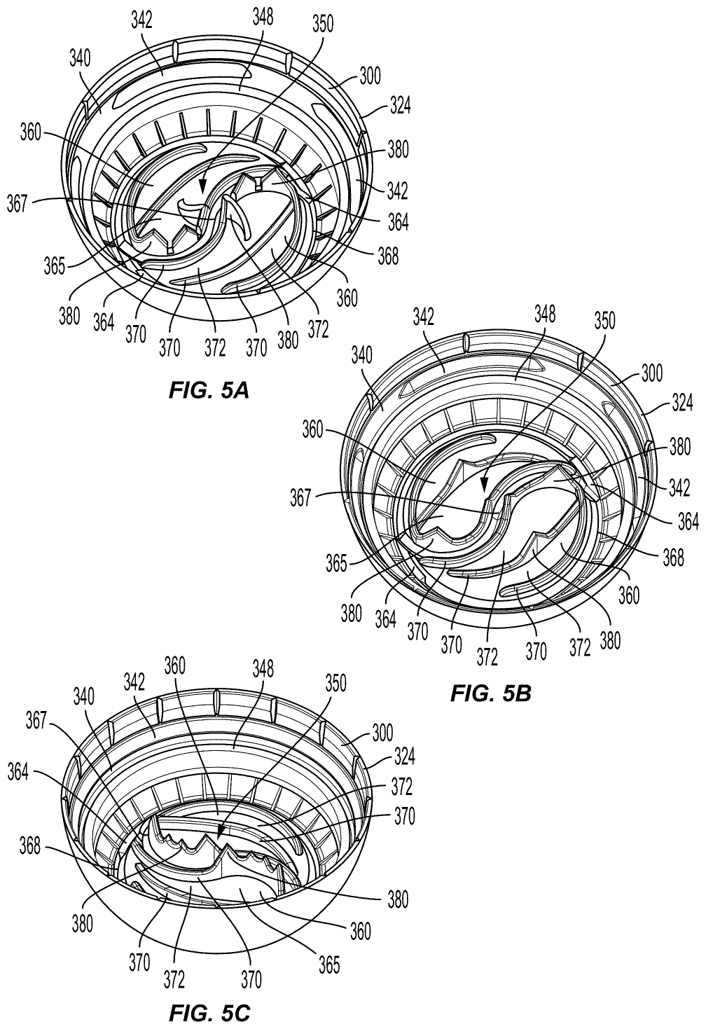

As shown in FIGS. 5A-5C, ridges 370 may be disposed on an interior surface 365 of flap 360 and extend vertically from interior surface 365. In some embodiments, a ridge 370 may follow portions of the inner and/or outer edges 367, 368 of flap 360. In some embodiments, a ridge 370 may be disposed on interior surface 365 between inner and outer edges 367, 368. Ridges 370 may provide rigidity to flap 360, for example, by increasing the bending stiffness of the flap 360. As described in further detail below, ridges 370 may direct the flow of beverage ingredients 120, 130 during a dispensing operation. In some embodiments, ridges 370 have a height of approximately 1-5 millimeters. In some embodiments, the height of the ridge 370 varies over its length.

Teeth 380 may be disposed on flap 360 and may extend into solid-ingredient chamber 330. Teeth 380 may extend toward liquid-ingredient-chamber film 232 and solid-ingredient-chamber film 332 and may be configured to puncture and/or tear liquid-ingredient-chamber film 232 and/or solid-ingredient-chamber film 332 during a dispensing operation. In some embodiments, teeth 380 have a generally triangular shape, however other shapes or structures capable of piercing chamber films 232, 332 in the manner described below may be used. In some embodiments, teeth 380 are disposed on ridges 370. In some embodiments, teeth 380 are disposed directly on interior surface 365 of flap 360 (e.g., not on a ridge). In some embodiments, teeth 380 are disposed along the inner and/or outer edges 367, 368 of flap 360. In some embodiments, teeth 380 are disposed between inner and outer edges 367, 368. In some embodiments, teeth 380 extend to a height of approximately 2-10 millimeters. In some embodiments, the maximum height of ridges 370 is approximately 10-50% of the maximum height of teeth 380.

FIGS. 5A-5C show three example configurations of cap 300, however cap 300 is not limited to what is shown in FIGS. 5A-5C, but may have other configurations. Any of caps 300 described herein (including caps 300 shown in FIGS. 5A-5C) may be used with body 200 in the manner described.

As described above, teeth 380 may be disposed in various locations on flap 360. For example, FIG. 5A shows a cap 300 with six teeth 380 disposed near inner edges 367 of flaps 360. Some teeth 380 are disposed on ridges 370, and other teeth 380 are disposed partially on ridges 370 and partially on interior surface 365. Further, some teeth 380 are oriented to follow the path of inner edges 367, and other teeth 380 are oriented to be substantially perpendicular to the path of inner edges 367. FIG. 5B shows another cap 300 with six teeth 380, where all of teeth 380 are disposed on ridges 370, and all of teeth 380 are oriented to follow the path of ridges 370. Some teeth 380 are disposed near inner edges 367 and other teeth 380 are disposed between and spaced apart from inner edges 367 and outer edges 368. As shown in FIGS. 5A and 5B, in some embodiments, teeth 380 are discrete and are not joined together. FIG. 5C shows another cap 300 with eight teeth, where all of teeth 380 are disposed on ridges 370 near inner edges 367, and all of teeth 380 are oriented to follow the path of ridges 370. As shown in FIG. 5C, in some embodiments, teeth 380 are not discrete but are joined together to form serrations.

In some embodiments where first opening 312 is circular, hinge 364 is positioned such that the radius of rotation 363 of the flap 360 is greater than the radius of the first opening 312. The radius of rotation 363 is the maximum radius of an arc formed by flap 360 when it is rotated about its hinge 364. In some embodiments, the radius of rotation 363 is the distance from hinge 364 to first end 361. In some embodiments, a tooth 380 is disposed on flap 360 such that the distance from the tooth 380 to the axis of rotation of the flap 360 (i.e., at the hinge 364) is greater than the radius of the first opening 312.

As shown in FIG. 4, when the cartridge 100 is in an assembled configuration, body 200 and cap 300 may be disposed in communication with one another. The shape of the exterior surface 202 of body 200 and the shape of the exterior surface 302 of cap 300 may be such that the exterior surfaces 202, 302 are substantially flush when the cartridge 100 is in an assembled configuration.

As shown in FIGS. 3-5C and 12, cap 300 may include body connection members 342 disposed on interior surface 340 of cap 300 that are configured to secure body 200 to cap 300. Body connection members 342 may be, for example, elevated surfaces, ridges, or the like configured such that body 200 and cap 300 may be secured together using a snap-fit connection, such as an annular snap-fit connection. Body connection members 342 may be disposed at intervals along interior surface 340 in a radial pattern (see, for example, FIGS. 5A and 5B). In some embodiments, a body connection member 342 is annular and continuous along interior surface 340 (see, for example, FIG. 5C).

A radius 218 (see FIG. 3) as measured from the center of body 200 to the outer edge 215 of annular rim 214, may be slightly greater than a radius 346, as measured from the center of cap 300 to the inner edge 344 of body connection members 342. During assembly, first end 210 of body 200 may be inserted into second opening 322 of cap 300, where annular rim 214 comes into contact with body connection members 342. As body 200 and cap 300 are pressed together, portions of body 200 and/or cap 300 elastically deform such that annular rim 214 may snap into place past body connection members 342. After body 200 has snapped into place with cap 300, a top surface 343 of body connection members 342 and sealing rim 348 secure annular rim 214 from below and above, respectively, to hold body 200 in place (see FIG. 12). As described in further detail below, cap 300 may include a tamper detection system 390 configured to provide visual indication if body 200 and cap 300 are disassembled after initial assembly.

As described above, in some embodiments, two chamber films 232, 332 are used to seal liquid-ingredient chamber 230 and solid-ingredient chamber 330, respectively. However, in some embodiments, only one film is used to seal both liquid-ingredient chamber 230 and solid-ingredient chamber 330. For example, a single film may be adhered to sealing rim 348 on one side and annular rim 214 on the other side, thus sealing both liquid-ingredient chamber 230 and solid-ingredient chamber 330. In some embodiments where two chamber films 232, 332 are used, an exterior surface 234 of liquid-ingredient-chamber film 232 and an exterior surface 334 of solid-ingredient-chamber film 332 may be attached together, forming a laminated structure. In some embodiments, chamber films 232, 332 may be attached together using an adhesive.

With reference to FIGS. 1 and 2, with cartridge piercer 16 in contact with exterior surface 366, an axial force 40 applied to the beverage ingredient cartridge 100 will cause cartridge piercer 16 to drive through dispensing end 110 of beverage ingredient cartridge 100, thereby causing flaps 360 to rotate inside of cap 300, and thereby causing teeth 380 to puncture and tear chamber films 232, 332. Cartridge piercer 16 may have sufficient rigidity to maintain its shape throughout the dispensing operation, and may apply a force to exterior surface 366 that is centrally located and normal to exterior surface 366.

FIGS. 7-9 show cartridge piercer 16—separately from other portions of bottle 10—and beverage ingredient cartridge 100 during such a dispensing operation. As external surfaces 366 of flaps 360 press against cartridge piercer 16, the two flaps 360 separate from second perimeter 324 along outer edges 368, and separate from one another along flap interface 369 (see FIG. 6) such that they may rotate independently about their respective hinges 364. As flaps 360 rotate, teeth 380 move toward and apply a force to solid-ingredient-chamber film 332 that is substantially normal to the chamber film 332, thereby causing the teeth to pierce through chamber film 332. Likewise, teeth 380 then move toward liquid-ingredient-chamber film 232 and apply a force to the chamber film 232 that is substantially normal to the chamber film 232, thereby causing the teeth to pierce through chamber film 232.

As mentioned above, forming the entirety of beverage ingredient cartridge 100 from PET can help improve recyclability. Thus, in some embodiments chamber films 232, 332 may be formed of PET. PET films may have a relatively high tensile strength (e.g., compared to a metal foil such as might otherwise be used to seal a container chamber). The piercing-and-then-tearing action of flaps 360 help effectively overcome the higher tensile strength of chamber films 232, 332, thereby allowing beverage ingredient cartridge 100 to be opened by a consumer with a single downward force applied to beverage ingredient cartridge, while also enabling the use of PET for chamber films 232, 332. This action also helps enable teeth 380 to effectively pierce and pass through chamber films 232, 332 in a way that creates a large hole 236 for release of beverage ingredients. In some embodiments, chamber films 232, 332 may be weakened (e.g., by a shallow score cut partially into chamber films 232, 332) or otherwise biased to break under the action of flaps 360. Once chamber films 232, 332 have been pierced, a hole 236 is formed in the films whereby liquid beverage ingredients 120 may be released from liquid-ingredient chamber 230.

In some embodiments, teeth 380 may pierce through solid-ingredient-chamber film 332 and liquid-ingredient-chamber film 232 simultaneously. In some embodiments, for example, where several teeth 380 are disposed at approximately the same distance from the axis of rotation of the flap 360 (see FIG. 5A), several teeth 380 of the same flap 360 engage and pierce chamber films 232, 332 simultaneously. In some embodiments, for example, where several teeth are disposed at various distances from the axis of rotation of the flap (see FIG. 5B), different teeth 380 of the same flap 360 engage and pierce chamber films 232, 332 at different stages of the dispensing operation.

As flaps 360 continue to move and rotate as cartridge piercer 16 moves further into the cartridge 100, teeth 380—which are oriented substantially normal to chamber films 232, 332—begin to rotate toward a direction that is parallel to the direction of extension of chamber films 232, 332. As shown in FIGS. 9 and 10, cartridge piercer 16 then forces flaps 360 to move in opposing directions, thus causing the teeth 380 on the two flaps 360 to begin applying opposing forces to the chambers films 232, 332 in a direction that is substantially tangent to the direction of extension of the chamber films 232, 332. Such opposing forces cause the chamber films 232, 332 to tear and/or stretch, enlarging hole 236 (which was initially created when teeth 380 punctured the chamber films 232, 332) such that liquid beverage ingredients 120 may be more rapidly released from liquid-ingredient chamber 230.

In some embodiments, teeth 380 tear one continuous hole 236 in chamber films 232, 332. In some embodiments, teeth 380 tear several holes 236 in chamber films 232, 332, some of which may enlarge and merge together through the tearing action described above. In some embodiments where several holes 236 are formed, liquid beverage ingredients 120 may flow out of one hole 236, and air may flow in another hole 236, thereby reducing the vacuum created in liquid-ingredient chamber 230, and thereby more rapidly dispensing liquid beverage ingredients 120. In some embodiments, the total areas of all holes 236 may be approximately 20-50% of the original area of the films.

As described above, some embodiments of beverage ingredient cartridge 100 are made entirely of one material (e.g., PET) such that the used, empty cartridge may be, for example, easily recycled in a single-stream recycling process. In order to achieve this uniformity of material, chamber films 232, 332 may be made of a material (e.g., PET) having a relatively high tensile strength compared to other materials (e.g., aluminum foil) that could be used to seal beverage ingredient chambers 230, 330 if such uniformity of material was not desired. An increase in the tensile strength of chamber films 232, 332 may also increase the axial force 40 necessary to dispense the contents of the cartridge, thereby decreasing the ease of use of the cartridge. However, opening mechanism 350 may be configured to compensate for the increased tensile strength of the films, such that the contents of the cartridge may be dispensed without necessitating a large axial force 40.

For example, as mentioned above, teeth 380 may apply a force to chamber films 232, 332 that is substantially normal to the chamber films 232, 332. In order to apply a force to the chamber films in a normal direction, teeth 380 may be disposed on flap 360 such that the distance from the teeth 380 to the axis of rotation of the flap 360 is greater than the radius of the first opening 312. Thus, the amount of rotation the flap 360 must undergo in order for teeth 380 to engage the chamber films 232, 332 is less than if the distance from the teeth 380 to the axis of rotation of the flap 360 were less than the radius of the first opening 312. Since teeth 380 extend from the flap 360 toward the chamber films 232, 332, decreasing the amount of rotation necessary for teeth 380 to engage the films may allow the teeth 380 to apply a force to the films in a substantially normal direction. By applying a force that is normal to the chamber films 232, 332, the force necessary to break the films may be less than if the force were applied to the chamber films 232, 332 in a non-normal direction. Thus, the axial force 40 required to puncture the chamber films may be less than if the teeth applied a force to the films that was not in a substantially normal direction.

Further, since teeth 380 first puncture chamber films 232, 332, then begin to tear chambers films 232, 332, the force required to create and enlarge holes 236 may be less than if the films were only punctured in a single direction, or if the chamber films 232, 332 were both punctured and torn concurrently. This may also reduce the axial force 40 required to break the chamber films.

In some embodiments, the magnitude of axial force 40 that is necessary to dispense the ingredients from beverage ingredient cartridge 100 into bottle 10 may be less than 30 pounds-force. In some embodiments, the magnitude of axial force 40 that is necessary to dispense the ingredients from beverage ingredient cartridge 100 into bottle 10 may be less than 20 pounds-force.

After liquid-ingredient-chamber film 232 has been pierced, liquid beverage ingredients 120 are first drawn by gravity through solid-ingredient chamber 330 and first opening 312, and finally into bottle 10. Solid beverage ingredients 130 not dispensed by the force of gravity may be washed out by liquid beverage ingredients 120 as they pass through solid-ingredient chamber 330. In this way, liquid beverage ingredients 120 and solid beverage ingredients 130 may begin to mix even before they exit beverage ingredient cartridge 100. After they exit, liquid beverage ingredients 120 and solid beverage ingredients 130 mix with liquid 20 within bottle 10 (see FIG. 1) to create beverage mixture 30 (see FIG. 2).

In some configurations, areas of solid-ingredient chamber 330—such as near hinges 364—may be prone to collecting solid beverage ingredients 130 that are not dispensed by the force of gravity or washed out by liquid beverage ingredients 120. Ridges 370 may direct the flow of some of the liquid beverage ingredients 120 through certain areas of solid-ingredient chamber 330 in order to increase the amount of solid beverage ingredients 130 that are washed out of solid-ingredient chamber 330 by liquid beverage ingredients 120. With reference to FIGS. 5A-5C, flow channels 372 may be formed between adjacent ridges 370 and may be used to direct the flow of liquid beverage ingredients 120. In some embodiments, teeth 380 may form part of the flow channels 372 and may help to direct the flow of liquid beverage ingredients 120. As liquid beverage ingredients 120 are drawn by gravity into solid-ingredient chamber 330, some of the liquid beverage ingredients 120 may fall onto interior surface 365 of flap 360 where flow channels 372 direct the flow of the liquid beverage ingredients 120 though certain areas of solid-ingredient chamber 330—such as near hinges 364—and then into bottle 10, thus increasing the amount of solid beverage ingredients 130 that are washed out by liquid beverage ingredients 120. In some embodiments, approximately 75-90% of the ingredients of the cartridge 100 may be dispensed into bottle 10 during a dispensing operation as described above. In some embodiments, greater than approximately 90% of the ingredients of the cartridge 100 may be dispensed into bottle 10 during a dispensing operation as described above.

In some embodiments, a temporary seal may be formed between exterior surface 202 and/or exterior surface 302 and engagement portion 14 (e.g., due to the application of force 40), such that bottle 10 and beverage ingredient cartridge 100, when held together by a user, can be shaken or otherwise moved without spilling liquid in order to further mix the ingredients that have been dispensed from the cartridge with the liquid in the bottle, and to rinse remaining ingredients out of beverage ingredient cartridge 100 and into the resulting beverage mixture 30.

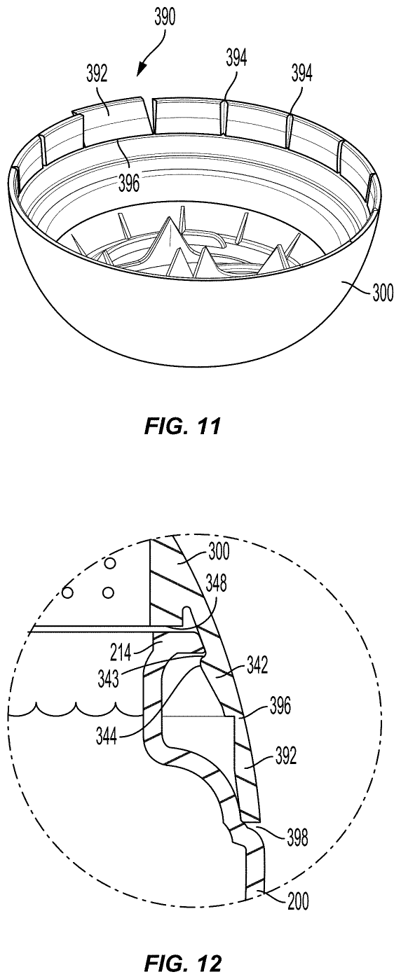

With reference to FIGS. 11 and 12, cap 300 may include a tamper detection system 390 configured to visually indicate to a user if the beverage ingredient cartridge 100 has been disassembled after initial assembly, or otherwise damaged or compromised. Tamper detection system 390 may include tabs 392 that are radially disposed around second end 320 of cap 300. Each of tabs 392 may be connected to cap 300 at a respective hinge 396, and adjacent tabs 392 may be connected to each other at weakened portions 394. Weakened portions 394 may be, for example, notches or the like that are sufficiently weakened such that, when a force is applied to tab 392 in a direction that is creates a moment about the axis of rotation of the tab (i.e., about hinge 396), weakened portions 394 may break, allowing the tab 392 to rotate about its hinge 396. As described above, body 200 and cap 300 may be connected together using a snap-fit connection. After body 200 and cap 300 have been joined during assembly, body 200 and/or cap 300 may need to be deformed (e.g., by prying) in order to again separate body 200 from cap 300. If, for example, a lever, such as a screw driver, is inserted between body 200 and cap 300 at a joint 398 in an attempt to pry body 200 and cap 300 apart, the lever may apply a force in a direction that creates a moment about the axis of rotation of tab 392, causing the adjacent weakened portions 394 to break, thereby causing the tab 392 to rotate about its hinge 396. The broken weakened portions 394 and/or the rotated tab 392 may be visible and evident, thus indicating to a user that the beverage ingredient cartridge 100 has been compromised. Such tamper detection systems 390 may be included on any of the caps 300 described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A beverage ingredient cartridge, comprising:
a body defining a first-ingredient chamber, wherein the first-ingredient chamber has an opening at an upper end of the body;
a first-ingredient-chamber film extending over the opening and sealing the first-ingredient chamber;
a cap defining a second-ingredient chamber, wherein the cap comprises an opening mechanism, and wherein the opening mechanism defines an upper side of the second-ingredient chamber; and
a second-ingredient-chamber film defining a lower side of the second-ingredient chamber,
wherein the opening mechanism comprises two flaps hingedly connected to an upper rim of the cap, wherein each of the flaps has teeth extending into the second-ingredient chamber,
wherein the flaps are rotatably movable from a closed position to an open position,
wherein, in the closed position, the flaps together form a flat circular shape and seal an upper side of the second-ingredient chamber,
wherein, when the flaps transition from the closed position to the open position, the teeth tear through both the second-ingredient-chamber film and the first-ingredient-chamber film, opening both the second-ingredient chamber and the first-ingredient chamber to an exterior of the beverage ingredient cartridge.

2. The beverage ingredient cartridge of claim 1, wherein each of the body, first-ingredient-chamber film, cap, and second-ingredient-chamber film is formed entirely of polyethylene terephthalate.

3. The beverage ingredient cartridge of claim 1, wherein the entirety of the beverage ingredient cartridge is formed entirely of polyethylene terephthalate, with the exception of any beverage ingredients contained therein.

4. The beverage ingredient cartridge of claim 1, wherein the first-ingredient-chamber film and the second-ingredient-chamber film are attached together.

5. The beverage ingredient cartridge of claim 4, wherein the films are attached together in a laminated structure.

6. The beverage ingredient cartridge of claim 4, wherein the films are attached together by an adhesive.

7. The beverage ingredient cartridge of claim 1, wherein an interface between the flaps in the closed position is curved.

8. The beverage ingredient cartridge of claim 1, wherein an interface between the flaps in the closed position is S-shaped.

9. The beverage ingredient cartridge of claim 1, wherein when the flaps are in the open position, and the teeth have torn through both the second-ingredient-chamber film and the first-ingredient-chamber film, both the second-ingredient chamber and the first-ingredient chamber are open to the exterior of the beverage ingredient cartridge through an opening previously closed by the flaps.

10. The beverage ingredient cartridge of claim 1, wherein the flaps are rotatably movable from the closed position to the open position upon a force applied centrally and normal to an outer surface of the closed flaps.

11. The beverage ingredient cartridge of claim 1, further comprising:
a liquid beverage ingredient disposed within the first-ingredient chamber; and
a solid beverage ingredient disposed within the second-ingredient chamber.

12. A beverage ingredient cartridge, comprising:
a film seal; and
an opening mechanism comprising:
only two flaps disposed above the film seal,
teeth disposed on each flap extending toward the film seal,
wherein outer edges of the two flaps together form a circle when in a closed position,
wherein each flap has an axis of rotation formed at an edge of the circle,
wherein a tooth of each flap is disposed a distance from its flap's axis of rotation that is greater than the radius of the circle.

13. The beverage ingredient cartridge of claim 12, wherein flaps are rotatable into an open position, and
wherein the teeth of the flaps tear an opening through the film seal when moved to the open position.

14. The beverage ingredient cartridge of claim 13, wherein the area of all openings torn through the film by the teeth when moved to the open position is at least 20% of the total area of the film.

15. The beverage ingredient cartridge of claim 13, wherein the beverage ingredient cartridge comprises two film seals, one sealing each of two ingredient chambers of the beverage ingredient cartridge.

16. The beverage ingredient cartridge of claim 15, wherein the teeth tear the two films simultaneously when the flaps are moved to the open position.

17. A beverage ingredient cartridge, comprising:
a body defining a first-ingredient chamber, wherein the first-ingredient chamber has an opening at an upper end of the body,
a first-ingredient-chamber film extending over the opening and sealing the first-ingredient chamber;
a cap defining a second-ingredient chamber, wherein the cap comprises an opening mechanism, and wherein the opening mechanism defines an upper side of the second-ingredient chamber;
a second-ingredient-chamber film defining a lower side of the second-ingredient chamber,
wherein the opening mechanism is configured to tear through both the first-ingredient-chamber film and the second-ingredient-chamber film by piercing and applying forces in opposing directions that are tangent to the direction of extension of the first-ingredient-chamber film and the second-ingredient-chamber film,
wherein each of the body, first-ingredient-chamber film, cap, and second-ingredient-chamber film is formed entirely of polyethylene terephthalate.

18. The beverage ingredient cartridge of claim 17, wherein the opening mechanism is configured to tear through both the first-ingredient-chamber film and the second-ingredient-chamber film under force applied to the cap.

19. The beverage ingredient cartridge of claim 17, further comprising:
a first beverage ingredient disposed within the first-ingredient chamber; and
a second beverage ingredient disposed within the second-ingredient chamber.

20. The beverage ingredient cartridge of claim 17, further comprising:
a tamper detection system, comprising:
tabs hingedly connected to the cap and disposed radially around an opening of the cap opposite the opening mechanism,
wherein each tab is connected to its adjacent tabs at weakened portions, and
wherein a force applied to a tab causes the tab to separate from its adjacent tabs and rotate about its hinge.
